(19) United States
(12) Patent Application Publication
(10) Pub. No.: US 2011/0185896 A1
(43) Pub. Date: Aug. 4, 2011

(54) GAS PURIFICATION PROCESSES

(76) Inventors: Rustam Sethna, Clinton, NJ (US); Russ Tietjen, Pittstown, NJ (US); Steve Eckhardt, Madison, NJ (US)

(21) Appl. No.: 12/728,571

(22) Filed: Mar. 22, 2010

Related U.S. Application Data
(60) Provisional application No. 61/300,501, filed on Feb. 2, 2010.

(51) Int. Cl. B01D 53/00; B01D 53/02; B01D 53/047; B01D 53/22; B01D 53/46

(52) U.S. Cl. 95/45; 95/136; 95/135; 95/139; 95/141; 95/90; 95/96; 95/133; 95/130; 95/98

(57) ABSTRACT

A method for removing contaminants from a natural gas stream such as a biogas/landfill gas stream. The natural gas stream is fed to a first adsorption unit for removal of certain contaminants and then to a second adsorption unit for the removal of additional contaminants. Alternatively, a membrane stage may be employed between the adsorption units. The method utilizes the external purge to enhance pressure swing adsorption working capacity so that the vacuum level required for regeneration is not as high.

### CROSS REFERENCE TO RELATED APPLICATIONS

The present application claims priority from U.S. Provisional Patent Application 61/300,501, filed Feb. 2, 2010.

### BACKGROUND OF THE INVENTION

The invention provides for a method for purifying natural gas. More particularly the invention provides for purifying biogas including digester gas and biogas from wastewater facilities and/or landfill gas.

Renewable methane can be recovered from a number of sources, such as anaerobic digestion of municipal or industrial waste streams, the degradation of biomass in landfills, or the gasification of waste and biomass streams, amongst others. In many instances, this renewable methane require purification before it can be used and/or sold into higher valued markets, such as injection into the pipeline grid, as a feedstock for liquefied natural gas (LNG), as a vehicle fuel, or as a feedstock for the production of hydrogen. Further, the energy that is required to purify the renewable methane is significant.

The cleanup of biogas/landfill gas is both capital and power intensive because it contains a large number of trace and bulk contaminants in fairly large concentrations. Various methods are employed to remove these including chilling, cryogenic methods and various adsorption and scrubbing processes. However, these processes can be expensive in both capital and operating costs and it is important to minimize these costs to achieve an economically viable process.

A typical process for the purification of the methane from biogas/landfill gas requires several steps. Sulfur removal is generally followed by drying. The dried gas stream is then treated for contaminants such a volatile organic compounds by process such as adsorption, CO2 washing or by cryogenic methods. The stream is then treated for bulk carbon dioxide removal by a membrane or adsorption process and then is treated for removal of nitrogen. All these purification steps are necessary before the biogas/landfill gas can be either liquefied and stored in anticipation of being dispensed, or directed towards other uses, such as pipeline injection, energy production with fuel cells or small-scale hydrogen production. LNG production is particularly challenging since all condensable contaminants including carbon dioxide must be removed to low ppm levels.

The invention uses a multibed adsorption system to remove the contaminants from the natural gas stream resulting in a purification system being more compact and efficient. The invention seeks to maximize methane recovery while eliminating the need for expensive vacuum pumps; reduce power consumption; allow operation at lower pressures; minimize the number of steps/unit operations to reduce installation and foundation costs; and improved system operability by having only one waste stream which is more steady.

### SUMMARY OF THE INVENTION

The invention provides for a method for removing contaminants from a natural gas stream comprising feeding the natural gas stream to a first adsorption unit, then feeding the natural gas stream to a second adsorption unit.

The first adsorption unit is typically a pressure swing adsorption (PSA) or vacuum swing adsorption (VSA) unit where organic compounds, siloxanes, water, sulfur-containing compounds and carbon dioxide are removed from the natural gas stream. The second adsorption unit which is also selected from a PSA or VSA unit will remove carbon dioxide and nitrogen from the natural gas stream.

The natural gas stream is typically recovered from a source such as the anaerobic digestion of municipal or industrial waste streams; the degradation of biomass in landfills or the gasification of waste and biomass streams, or coal seam methane, or pipeline gas.

In an alternative embodiment, the invention provides for a method for removing contaminants from a natural gas stream comprising feeding the natural gas stream to a first adsorption unit; then feeding the natural gas stream to a guard bed; then feeding the natural gas stream to a second adsorption unit.

As in the first embodiment, the first and second adsorption units may be selected from PSA or VSA units. The guard bed is a granular activated carbon bed for polishing contaminants from the methane gas stream which will improve operation of the second adsorption unit.

The adsorption units are typically multi-bed systems featuring multiple layers of adsorbent materials. These adsorption materials will assist in removing the different contaminants in the natural gas stream.

First multi-bed, multilayer PSA has all/some of these alumina (including promoted aluminas) or silica gel and molecular sieve materials which have an affinity for carbon dioxide, water, NMOCs (non-methane organic compounds), H₂S, and other sulfur compounds, etc. It is important to minimize H₂S hydrolysis which might result in COS formation and require further removal. Hence, the choice of materials is important.

The second multi-bed, multilayer PSA/VSA can have aluminas, silica gel, and mol sieves that can remove N₂, CO₂ as well as sulfur compounds. This includes, pore size controlled aluminosilicate, titanosilicate and carbon molecular sieve materials and purified, ion-exchanged or mixed ion Clinoptilites.

The first PSA can also be a temperature swing adsorption (TSA) unit. These have the inherent problem that the high regeneration temperatures necessary, ca. 500° F., can result in reactions on the alumina and molecular sieve materials which would lower their effectiveness.

Both systems can be continuous adsorption methods like a rotating bed PSA/VSA, or a rotary valve PSA/VSA. Any combination of regenerative adsorption techniques should be covered. These have a significant advantage in that they eliminate or reduce the need for buffer tanks, allow for easier controls and plant operation and more stable waste flows that facilitate flare operation or use in an engine for power generation. The waste flows from the plant are stable and continuous and more readily flared. Additionally, the waste stream can be combined with additional biogas/landfill gas for power generation.

The guard bed is typically granular activated carbon (GAC), but can include other sacrificial layers to remove halogenated compounds, trace heavy metals and residual siloxanes. Sometimes, chilling is used in conjunction with this for higher capacity or more effective contaminant removal.

Chilling can also be used upstream of the first PSA to lower the water and VOC load on the unit so that it can produce cleaner gas and/or have greater cleanup capacity.

Alternatively and particularly for the second adsorption unit, a rotary bed/rotary valve system can be employed. This will allow operation of the adsorption cycle to be continuous, rather than in discrete fashion were it a fixed adsorbent bed.

The invention may also use one or two membrane stages in series which receives the purified natural gas from the guard bed before feeding to the second adsorption unit. A permeate stream from the membrane unit may also be used by itself or combined with tail gas from the second adsorption unit to regenerate the adsorbent beds in the first adsorbent unit.

Earlier biogas/landfill gas purification processes required several steps to remove the contaminants that the invention removes. A typical process is shown in FIG. 1 where sulfur compounds are first removed from the biogas/landfill gas stream. The stream is then dried and directed to a unit operation where non-methane organic compounds and other contaminants are removed. Carbon dioxide is removed in bulk in the next stage, after which nitrogen is removed from the biogas/landfill gas stream. The purified stream can then be liquefied and stored and made ready for dispensing. Other uses include generating power with an engine or fuel cell.

### BRIEF DESCRIPTION OF THE DRAWINGS

FIG. 1 is a schematic of an earlier process for biogas/landfill gas purification versus the process of the invention.

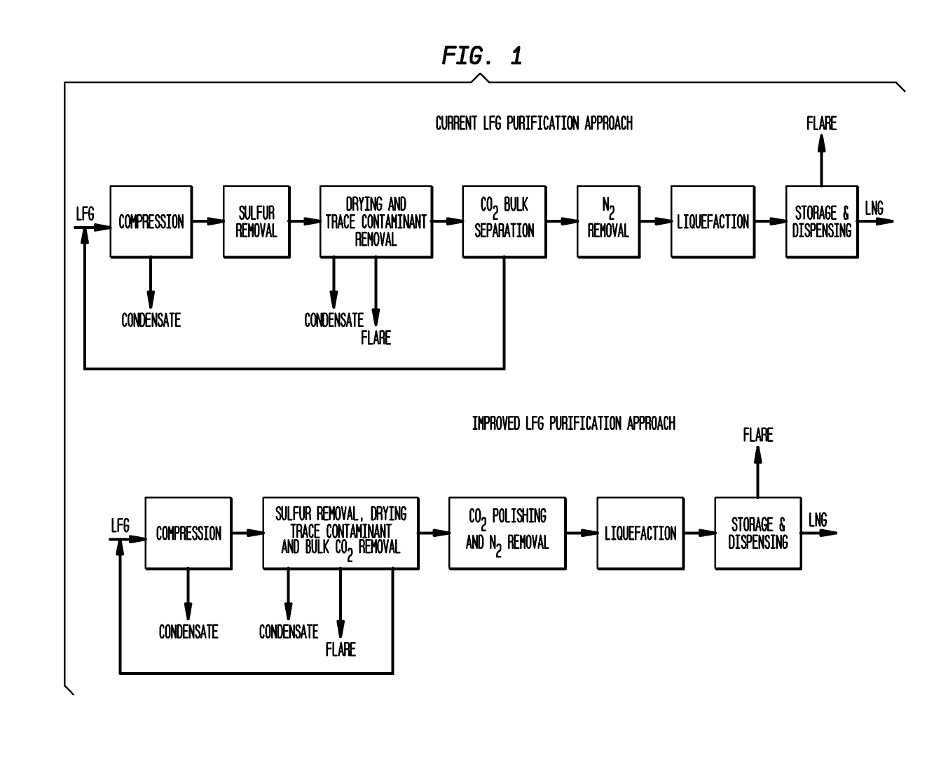

FIG. 2 is a schematic of an integrated biogas/landfill gas purification system according to the invention.

FIG. 3 a schematic of an integrated biogas/landfill gas purification system with a guard bed according to the invention.

FIG. 4 is a schematic of an integrated biogas/landfill gas purification system with a guard bed according to the invention.

FIG. 5 is a schematic of an integrated biogas/landfill gas purification system with a guard bed according to the invention coupled to a gas engine.

### DETAILED DESCRIPTION OF THE INVENTION

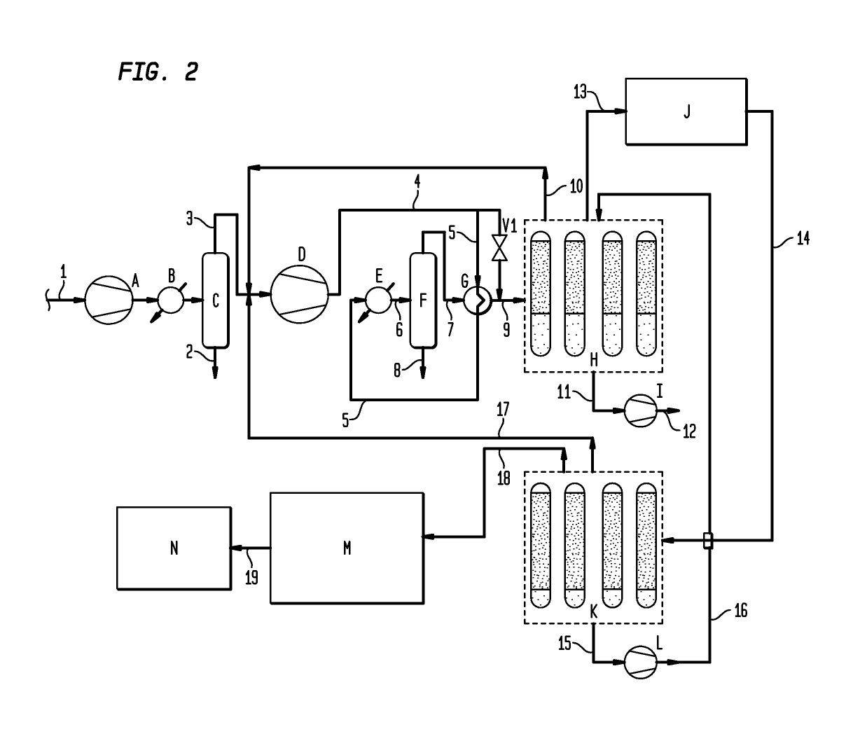

FIG. 2 is a schematic of a gas purification system having two adsorption units. Raw landfill gas is fed through line 1 into a feed blower A and through heat exchanger B into condenser C. Condensate is removed from the condenser C through line 2 and the gas stream exiting the condenser C through line 3 enters feed compressor D. The landfill gas is primarily composed of methane gas but contains a variety of contaminants, including water. The condenser will assist in removing water and non-methane organic compounds (NMOCs).

The landfill gas stream will exit the feed compressor D at a pressure of 80 to 250 psig through line 4 and valve V1 to contact line 9 which enters the first adsorption unit H. The compressed landfill gas stream may also enter line 5 through heat exchanger G before entering heat exchanger E and is directed through line 6 to a condenser F where condensate will be removed by line 8 and the gaseous portion fed through line 7 into G and line 9 into the first adsorption unit H.

The first adsorption unit H comprises a multi-bed, multilayer pressure swing adsorption (PSA) or vacuum swing adsorption (VSA) for the removal of water, non-methane organic compounds such as siloxanes, hydrogen sulfide and bulk carbon dioxide. Some oxygen is also rejected by this step. The first adsorption unit may comprise two or more adsorption beds. These beds are multi-layered and filled with relevant adsorption materials to remove the above-identified contaminants. The adsorption beds may contain silica gel, activated alumina, promoted activated alumina, carbon molecular sieves (CMS) and molecular sieves such as X and Y type zeolite materials.

The first adsorption unit may be fixed or it may be a rotary bed/rotary valve pressure swing adsorption unit.

The waste gas stream from the first adsorption H will exit through line 11 and blower/vacuum pump I to be flared through line 12. This waste gas stream will be rich in non-methane organic compounds, hydrogen sulfide, carbon dioxide and moisture.

Part of the purified landfill gas stream will exit the first adsorption unit through line 10 and be fed through line 3, feed compressor D and line 4 back into line 9 for feeding back into the first adsorption unit H to supplement the original feed of raw landfill gas. The purified landfill gas stream will exit the first adsorption unit H through line 13 and be directed to the guard bed J. The guard bed J will remove trace contaminants in the purified landfill gas stream that may contact a second adsorbent unit and impair the efficiency of the second adsorption unit. The purified landfill gas stream will leave the guard bed J through line 14 and enter the second adsorbent unit K.

The second adsorption unit K is a multi-bed, multilayer vacuum swing adsorption (VSA) system for carbon dioxide polishing and nitrogen removal, as well as some oxygen removal. The VSA system will comprise two or more bed and will contain appropriate adsorbent materials for removing carbon dioxide, nitrogen and to a lesser extend oxygen. These materials are selected from the group consisting of silica gel, activated alumina, pore size controlled aluminosilicate, titanosilicate and carbon molecular sieve materials and Clinoptilolites (purified, ion-exchanged and mixed ion).

The second adsorption unit K may also be a fixed unit or a rotary bed/rotary valve vacuum swing adsorption system.

The purified landfill gas will exit the second adsorption unit through line 18 where it will be liquefied in liquefier M and directed through line 19 for storage and dispensing N. The waste gas stream of carbon dioxide, nitrogen and oxygen from the second adsorption unit K will be fed to a vacuum pump L through line 15 and fed back to the first adsorption unit H through line 16 to act as a purge gas for the regeneration of the pressure swing adsorption/vacuum swing adsorption beds in place in the first adsorption unit H. This is an important differentiator from earlier methane gas stream purification systems as normally a large vacuum pump would be used to help regenerate the beds of the first adsorption unit. The methods of the invention allow for the use of a smaller vacuum pump or none at all which will account for both capital and power consumption savings while maintaining high purified methane recoveries.

Some of the purified landfill gas will also exit the second adsorption unit K through line 17 where it is fed through line 3, feed compressor D and line 4 back into line 9 for feeding back into the first adsorption unit H to supplement the original feed of raw landfill gas.

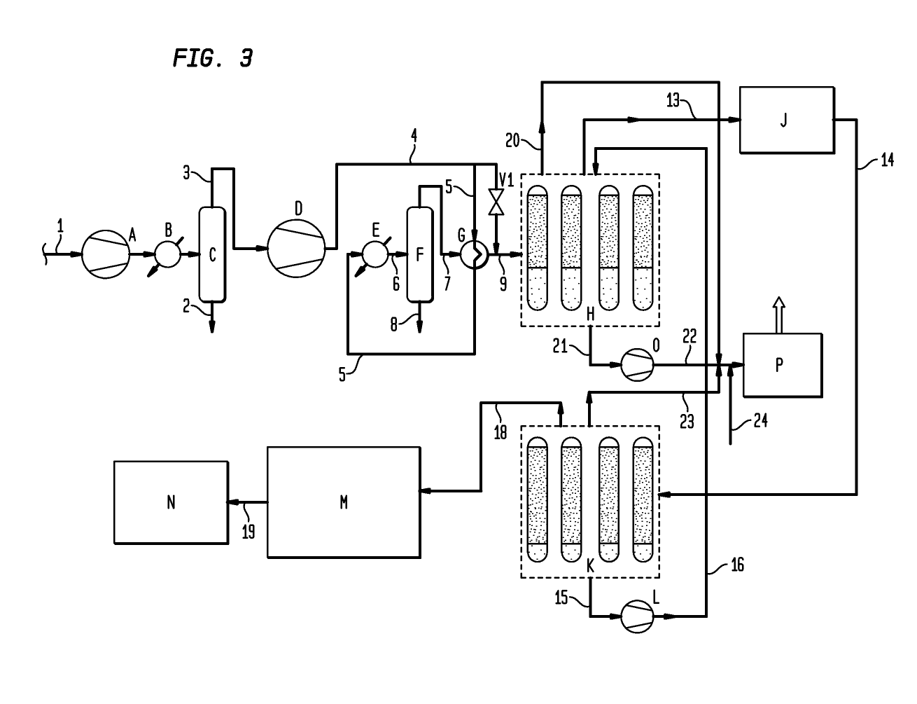

FIG. 3 in operation is similar to FIG. 2. Like systems in FIG. 2 will bear the same numbering system as FIG. 2 with the newly introduced concepts added as new numbers.

Raw landfill gas is fed through line 1 into a feed blower A and through heat exchanger B into condenser C. Condensate is removed from the condenser C through line 2 and the gas stream exiting the condenser C through line 3 enters feed compressor D. The landfill gas is primarily composed of methane gas but contains a variety of contaminants, including water. The condenser will assist in removing water and non-methane organic compounds (NMOCs).

The landfill gas stream will exit the feed compressor D at a pressure of 80 to 250 psig through line 4 and valve V1 to contact line 9 which enters the first adsorption unit H. The compressed landfill gas stream may also enter line 5 through G (what is this?) before entering heat exchanger E and is directed through line 6 to a condenser F where condensate will be removed by line 8 and the gaseous portion fed through line 7 into G and line 9 into the first adsorption unit H.

The first adsorption unit H comprises a multi-bed, multilayer pressure swing adsorption (PSA) or vacuum swing adsorption (VSA) for the removal of water, non-methane organic compounds such as siloxanes, hydrogen sulfide and bulk carbon dioxide. Some oxygen is also rejected by this step. The first adsorption unit may comprise two or more adsorption beds. These beds are multi-layered and filled with relevant adsorption materials to remove the above-identified contaminants. The adsorption beds may contain silica gel, activated alumina, promoted activated alumina, carbon molecular sieves (CMS) and molecular sieves such as X and Y type zeolite materials.

The first adsorption unit may be fixed or it may be a rotary bed/rotary valve pressure swing adsorption unit.

The waste gas stream from the first adsorption unit H which comprises non-methane organic compounds, hydrogen sulfide, carbon dioxide and moisture exit the first adsorption unit H through line 21 and is fed to a blower/vacuum pump O which directs this waste gas stream through line 22 into a gas engine P. The gas engine P is designed to generate power which can be used by the plant operator in a variety of settings. Alternatively other power generating equipment, such as microturbines and fuel cells may be employed in place of the gas engine.

Part of the purified landfill gas stream will exit the first adsorption unit through line 20 and be directed to line 22 where it will enter the gas engine P.

The waste gas stream from the first adsorption H will exit through line 11 and blower/vacuum pump I to be flared through line 12. This waste gas stream will be rich in non-methane organic compounds, hydrogen sulfide, carbon dioxide and moisture.

The purified landfill gas stream will exit the first adsorption unit H through line 13 and be directed to the guard bed J. The guard bed J will remove any leftover trace contaminants in the purified landfill gas stream that may contact a second adsorbent unit and impair the efficiency of the second adsorption unit. The purified landfill gas stream will leave the guard bed J through line 14 and enter the second adsorbent unit K.

The second adsorption unit K is a multi-bed, multilayer vacuum swing adsorption (VSA) system for carbon dioxide polishing and nitrogen removal, as well as some oxygen removal. The VSA system will comprise two or more bed and will contain appropriate adsorbent materials for removing carbon dioxide, nitrogen and to a lesser extend oxygen. These materials are selected from the group consisting of silica gel, activated alumina, pore size controlled aluminosilicate, titanosilicate and carbon molecular sieve materials and Clinoptilolites (purified, ion-exchanged and mixed ion).

The second adsorption unit K may also be a fixed unit or a rotary bed/rotary valve vacuum swing adsorption system.

The purified landfill gas will exit the second adsorption unit through line 18 where it will be liquefied in liquefier M and directed through line 19 for storage and dispensing N. The waste gas stream of carbon dioxide, nitrogen and oxygen from the second adsorption unit K will be fed to a vacuum pump L through line 15 and fed back to the first adsorption unit H through line 16 to act as a purge gas for the regeneration of the pressure swing adsorption/vacuum swing adsorption beds in place in the first adsorption unit H. This embodiment also allows for the use of a smaller vacuum pump or none at all to account for both capital and power consumption savings while maintaining high purified methane gas recoveries. Part of the product gas stream from second adsorption unit K may also be directed through line 23 where it will join with the other gas streams 20, 22 and makeup gas stream 24 for entry as fuel for gas engine P.

Thus, two successive external purges are more effective in cleaning the beds (PSA H). This requires less vacuum to pull off the adsorbed contaminants and regenerate the beds. The first external purge is the membrane permeate which has a higher carbon dioxide content than the nitrogen rejection unit (NRU) waste gas and serves to partially regenerate the beds by pushing the adsorbed contaminants further down the beds. The second NRU waste purge has very little carbon dioxide and can further regenerate the beds.

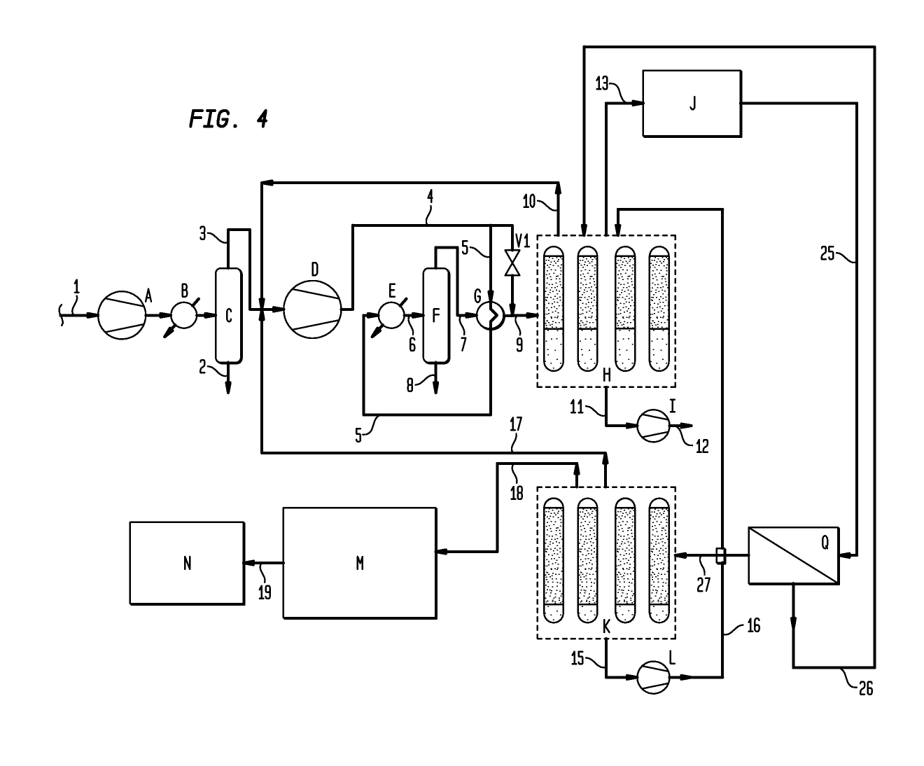

FIG. 4 is a further embodiment of the invention and is similar in operation to the invention described in FIG. 2. Raw landfill gas is fed through line 1 into a feed blower A and through heat exchanger B into condenser C. Condensate is removed from the condenser C through line 2 and the gas stream exiting the condenser C through line 3 enters feed compressor D. The landfill gas is primarily composed of methane gas but contains a variety of contaminants, including water. The condenser will assist in removing water and non-methane organic compounds (NMOCs).

The landfill gas stream will exit the feed compressor D at a pressure of 80 to 250 psig through line 4 and valve V1 to contact line 9 which enters the first adsorption unit H. The compressed landfill gas stream may also enter line 5 through G (what is this?) before entering heat exchanger E and is directed through line 6 to a condenser F where condensate will be removed by line 8 and the gaseous portion fed through line 7 into G and line 9 into the first adsorption unit H.

The first adsorption unit H comprises a multi-bed, multilayer pressure swing adsorption (PSA) or vacuum swing adsorption (VSA) for the removal of water, non-methane organic compounds such as siloxanes, hydrogen sulfide and bulk carbon dioxide. Some oxygen is also rejected by this step. The first adsorption unit may comprise two or more adsorption beds. These beds are multi-layered and filled with relevant adsorption materials to remove the above-identified contaminants. The adsorption beds may contain silica gel, activated alumina, promoted activated alumina, carbon molecular sieves (CMS) and molecular sieves such as X and Y type zeolite materials.

The first adsorption unit may be fixed or it may be a rotary bed/rotary valve pressure swing adsorption unit.

The waste gas stream from the first adsorption H will exit through line 11 and blower/vacuum pump I to be flared through line 12. This waste gas stream will be rich in non-methane organic compounds, hydrogen sulfide, carbon dioxide and moisture.

Part of the purified landfill gas stream will exit the first adsorption unit through line 10 and be fed through line 3, feed compressor D and line 4 back into line 9 for feeding back into the first adsorption unit H to supplement the original feed of raw landfill gas. The purified landfill gas stream will exit the first adsorption unit H through line 13 and be directed to the guard bed J. The guard bed J will remove trace contaminants in the purified landfill gas stream that may contact a second adsorbent unit and impair the efficiency of the second adsorption unit. The purified landfill gas stream will leave the guard bed J and line 25 through a membrane unit Q. The membrane unit Q will remove oxygen and the rest of the carbon dioxide. A lower amount of carbon dioxide present in the landfill gas stream being purified will mean a greater portion of nitrogen removal in the second adsorption unit K will be for nitrogen rejection. The membrane material is selected from the group consisting of aromatic polyimide hollow fiber membranes, cellulose acetate, polyimides, polyamides, polysulfone, polycarbonates and polyetherimide. The permeate gas which consists of oxygen, carbon dioxide, nitrogen and some methane will exit the membrane unit Q through line 26 and be directed to the first adsorption unit H where this gas mixture will act as a regeneration gas for the regeneration of the adsorbent beds in the first adsorption unit H. The landfill gas stream will exit the membrane unit Q through line 27 where it will enter the second adsorption unit K.

The second adsorption unit K is a multi-bed, multilayer vacuum swing adsorption (VSA) system for carbon dioxide polishing and nitrogen removal, as well as some oxygen removal. The VSA system will comprise two or more bed and will contain appropriate adsorbent materials for removing carbon dioxide, nitrogen and to a lesser extend oxygen. These materials are selected from the group consisting of silica gel, activated alumina, pore size controlled aluminosilicate, titanosilicate and carbon molecular sieve materials and Clinoptilolites (purified, ion-exchanged and mixed ion).

The second adsorption unit K may also be a fixed unit or a rotary bed/rotary valve vacuum swing adsorption system.

The purified landfill gas will exit the second adsorption unit through line 18 where it will be liquefied in liquefier M and directed through line 19 for storage and dispensing N. The waste gas stream of carbon dioxide, nitrogen and oxygen from the second adsorption unit K will be fed to a vacuum pump L through line 15 and fed back to the first adsorption unit H through line 16 to act as a purge gas for the regeneration of the pressure swing adsorption/vacuum swing adsorption beds in place in the first adsorption unit H. This is an important differentiator from earlier methane gas stream purification systems as normally a large vacuum pump would be used to help regenerate the beds of the first adsorption unit. The methods of the invention allow for the use of a smaller vacuum pump or none at all which will account for both capital and power consumption savings while maintaining high purified methane recoveries.

A typical cycle would look like this:

A↑

| | |
|---|---|
| EQ1↑ | PP↑ |
| D↓ | P1↓ P2↓ |
| EQ1↓ | R↓ |

Some of the purified landfill gas will also exit the second adsorption unit K through line 17 where it is fed through line 3, feed compressor D and line 4 back into line 9 for feeding back into the first adsorption unit H to supplement the original feed of raw landfill gas.

Regeneration with permeate (containing some carbon dioxide) followed by regeneration with tail gas of PSA H from VSA K allows cleaner beds for PSA H as explained previously. This makes PSA H more effective for contaminant removal and significantly smaller vacuum pump I.

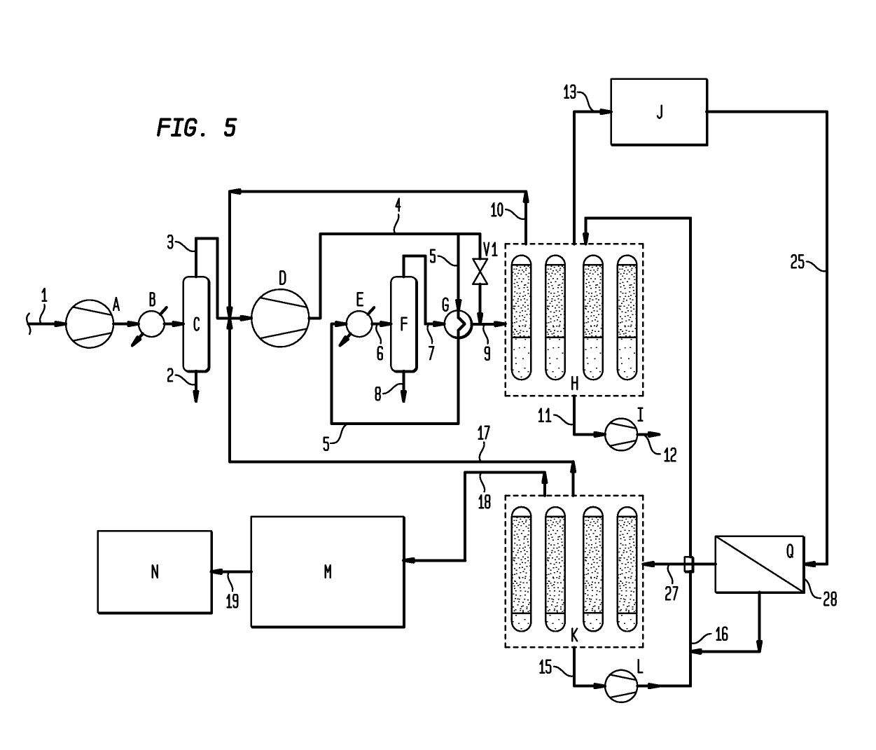

FIG. 5 is a further embodiment of the invention and is similar in operation to the invention described in FIG. 4. Raw landfill gas is fed through line 1 into a feed blower A and through heat exchanger B into condenser C. Condensate is removed from the condenser C through line 2 and the gas stream exiting the condenser C through line 3 enters feed compressor D. The landfill gas is primarily composed of methane gas but contains a variety of contaminants, including water. The condenser will assist in removing water and non-methane organic compounds (NMOCs).

The landfill gas stream will exit the feed compressor D at a pressure of 80 to 250 psig through line 4 and valve V1 to contact line 9 which enters the first adsorption unit H. The compressed landfill gas stream may also enter line 5 through G (what is this?) before entering heat exchanger E and is directed through line 6 to a condenser F where condensate will be removed by line 8 and the gaseous portion fed through line 7 into G and line 9 into the first adsorption unit H.

The first adsorption unit H comprises a multi-bed, multilayer pressure swing adsorption (PSA) or vacuum swing adsorption (VSA) for the removal of water, non-methane organic compounds such as siloxanes, hydrogen sulfide and bulk carbon dioxide. Some oxygen is also rejected by this step. The first adsorption unit may comprise two or more adsorption beds. These beds are multi-layered and filled with relevant adsorption materials to remove the above-identified contaminants. The adsorption beds may contain silica gel, activated alumina, promoted activated alumina, carbon molecular sieves (CMS) and molecular sieves such as X and Y type zeolite materials.

The first adsorption unit may be fixed or it may be a rotary bed/rotary valve pressure swing adsorption unit.

The waste gas stream from the first adsorption H will exit through line 11 and blower/vacuum pump I to be flared through line 12. This waste gas stream will be rich in non-methane organic compounds, hydrogen sulfide, carbon dioxide and moisture.

Part of the purified landfill gas stream will exit the first adsorption unit through line 10 and be fed through line 3, feed compressor D and line 4 back into line 9 for feeding back into the first adsorption unit H to supplement the original feed of raw landfill gas. The purified landfill gas stream will exit the first adsorption unit H through line 13 and be directed to the guard bed J. The guard bed J will remove trace contaminants in the purified landfill gas stream that may contact a second adsorbent unit and impair the efficiency of the second adsorption unit. The purified landfill gas stream will leave the guard bed J and line 25 through a membrane unit Q. The membrane unit Q will remove oxygen and carbon dioxide. A lower amount of carbon dioxide present in the landfill gas stream being purified will mean a greater portion of nitrogen removal in the second adsorption unit K will be for nitrogen rejection. The membrane material is selected from the group consisting of aromatic polyimide hollow fiber membranes, cellulose acetate, polyimides, polyamides, polysulfone, polycarbonates and polyetherimide. The permeate gas which consists of oxygen, carbon dioxide, nitrogen and some methane will exit the membrane unit Q through line 28 and be directed to line 16 where it will be fed back to the first adsorption unit HU to regenerate the adsorbent beds contained therein.

The landfill gas stream will exit the membrane unit Q through line 27 where it will enter the second adsorption unit K.

The second adsorption unit K is a multi-bed, multilayer vacuum swing adsorption (VSA) system for carbon dioxide polishing and nitrogen removal, as well as some oxygen removal. The VSA system will comprise two or more bed and will contain appropriate adsorbent materials for removing carbon dioxide, nitrogen and to a lesser extend oxygen. These materials are selected from the group consisting of silica gel, activated alumina, pore size controlled aluminosilicate, titanosilicate and carbon molecular sieve materials and Clinoptilolites (purified, ion-exchanged and mixed ion).

The second adsorption unit K may also be a fixed unit or a rotary bed/rotary valve vacuum swing adsorption system.

The purified landfill gas will exit the second adsorption unit through line 18 where it will be liquefied in liquefier M and directed through line 19 for storage and dispensing N. The waste gas stream of carbon dioxide, nitrogen and oxygen from the second adsorption unit K will be fed to a vacuum pump L through line 15 and fed back to the first adsorption unit H through line 16 to act as a purge gas for the regeneration of the pressure swing adsorption/vacuum swing adsorption beds in place in the first adsorption unit H. This is an important differentiator from earlier methane gas stream purification systems as normally a large vacuum pump would be used to help regenerate the beds of the first adsorption unit. The methods of the invention allow for the use of a smaller vacuum pump or none at all which will account for both capital and power consumption savings while maintaining high purified methane recoveries.

Some of the purified landfill gas will also exit the second adsorption unit K through line 17 where it is fed through line 3, feed compressor D and line 4 back into line 9 for feeding back into the first adsorption unit H to supplement the original feed of raw landfill gas.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention

Having thus described the invention, what we claim is:

1. A method for removing contaminants from a natural gas stream comprising feeding the natural gas stream to a first adsorption unit, then feeding the natural gas stream to a second adsorption unit.

2. The method as claimed in claim 1 wherein said contaminants are selected from the group consisting of water, non-methane organic compounds, hydrogen sulfides, carbonyl sulfide and carbon dioxide.

3. The method as claimed in claim 1 wherein said natural gas stream is condensed before entering said first adsorption unit.

4. The method as claimed in claim 1 wherein said natural gas stream is compressed to a pressure of 80 to 250 psig before entering said first adsorption unit.

5. The method as claimed in claim 3 wherein said natural gas stream is condensed twice before entering said first adsorption unit.

6. The method as claimed in claim 1 wherein said first adsorption unit is selected from the group consisting of pressure swing adsorption and vacuum swing adsorption units.

7. The method as claimed in claim 6 wherein said adsorption unit comprises two or more adsorption beds.

8. The method as claimed in claim 6 wherein said first adsorption unit comprises multi-layer adsorbent beds.

9. The method as claimed in claim 8 wherein said multi-layer adsorbent beds contain an adsorbent material selected from the group consisting of silica gel, activated alumina, promoted activated alumina, carbon molecular sieves (CMS) and molecular sieves such as X and Y type zeolite materials

10. The method as claimed in claim 7 wherein said adsorption beds are selected from the group consisting of rotary beds and fixed beds.

11. The method as claimed in claim 1 wherein purified natural gas from said first adsorption unit is fed to a guard bed.

12. The method as claimed in claim 11 wherein said guard bed removes halogenated compounds, trace heavy metals and residual siloxanes and VOCs from said purified natural gas stream.

13. The method as claimed in claim 1 wherein said purified natural gas is fed from said guard bed to said second adsorption unit.

14. The method as claimed in claim 1 wherein said second adsorption unit removes carbon dioxide and nitrogen from said purified natural gas.

15. The method as claimed in claim 1 wherein said second adsorption unit is selected from the group consisting of pressure swing adsorption and vacuum swing adsorption units.

16. The method as claimed in claim 15 wherein said second adsorption unit comprises two or more adsorption beds.

17. The method as claimed in claim 15 wherein said second adsorption unit comprises multi-layer adsorbent beds.

18. The method as claimed in claim 17 wherein said multi-layer adsorbent beds contain an adsorbent material selected from the group consisting of silica gel, activated alumina, promoted activated alumina, carbon molecular sieves (CMS) and molecular sieves such as X and Y type zeolite materials

19. The method as claimed in claim 16 wherein said adsorption beds are selected from the group consisting of rotary beds and fixed beds.

20. The method as claimed in claim 1 wherein purified natural gas is recovered from said second adsorption unit.

21. The method as claimed in claim 1 wherein said purified natural gas is fed from said second adsorption unit to said feed of natural gas to said first adsorption unit.

22. The method as claimed in claim 19 wherein a waste gas stream from said second adsorption unit is fed to said first adsorption unit to regenerate said adsorption beds.

23. The method as claimed in claim 1 wherein depressurization gas from said first adsorption unit is fed to a power generation unit.

24. The method as claimed in claim 1 wherein purified natural gas from said second adsorption unit is fed to a power generation unit.

25. The method as claimed in claim 1 wherein a tail gas from said first adsorption unit is fed to a power generation unit.

26. The method as claimed in claim 25 wherein said power generation unit is selected from the group consisting of a gas engine, microturbine and fuel cell.

27. The method as claimed in claim 11 wherein said purified natural gas is fed from said guard bed to a membrane unit.

28. The method as claimed in claim 27 wherein a permeate stream from said membrane unit is fed to said second adsorption unit.

29. The method as claimed in claim 26 wherein a permeate stream from said membrane unit is fed to said first adsorption unit to regenerate said adsorption beds.

30. The method as claimed in claim 29 wherein said regeneration of said adsorption beds is followed by regeneration of said adsorption beds by tail gas from said second adsorption unit.

31. The method as claimed in claim 29 wherein said permeate stream from said membrane unit is combined with a tail gas stream from said second adsorption unit and is fed to said first adsorption unit to regenerate said adsorption beds.

32. The method as claimed in claim 27 wherein said membrane is selected from the group consisting of aromatic polyimide hollow fiber membranes, cellulose acetate, polyimides, polyamides, polysulfone, polycarbonates and polyetherimide
